(19) United States
(12) Patent Application Publication
(10) Pub. No.: US 2007/0220335 A1
(43) Pub. Date: Sep. 20, 2007

(54) Hardware function isolating during slow mode initial program loading

(76) Inventors: Marc Avery Gollub, Round Rock, TX (US); Chuon Wei Liu, Austin, TX (US)

Correspondence Address: IBM CORP (YA);C/O YEE & ASSOCIATES PC, P.O. BOX 802333, DALLAS, TX, 75380, US

(21) Appl. No.: 11/364,765

(22) Filed: Feb. 28, 2006

(51) Int. Cl. G06F 11/00

(52) U.S. Cl. 714/30

(57) ABSTRACT

A computer implemented method, apparatus, and computer usable program code for performing a diagnostic in a hardware component established in a data processing system. The method includes starting a first slow mode initial program loading in the hardware component, wherein the hardware component contains a first diagnostic routine. A determination is made whether the first diagnostic routine fails during the slow mode initial program loading. Responsive to a determination that the first diagnostic routine fails, the first diagnostic routine is isolated.

### BACKGROUND OF THE INVENTION

1. Field of the Invention

The present invention relates generally to an improved data processing system and in particular to diagnostic routines in hardware used in data processing systems. Still more particularly, the present invention relates to a computer implemented method, apparatus, and computer usable program code for isolating individual diagnostic routines within the hardware.

2. Description of the Related Art

Modern hardware components can be complex devices having multiple functionalities. Each of these functionalities can be, for example, a function that the hardware component performs, or a sub-component of the hardware component or programs incorporated with the hardware component. These hardware components can be provided with one or more diagnostic routines that are used to diagnose non-functioning functionalities of the hardware component.

One issue that can arise when performing multiple diagnostic routines, is that errors that occur or are found in one functionality or diagnostic routine can cause errors in other functionalities or diagnostic routines. For example, certain-functions performed during slow mode initial program loading requires turning on and off clocks and re-synchronizing the bus system of the hardware component. However, when these functions are performed, a fault isolation register bit can be “turned on” and cause a following function to fail. In another example, a function might not be properly reset after performing a diagnostic. This condition can cause other functionalities or diagnostics of the hardware component to fail. Additionally, if an error is found in a functionality of a hardware component, replacing the entire component may not be desirable.

### SUMMARY OF THE INVENTION

The present invention provides for a computer implemented method, apparatus, and computer usable program code for performing a diagnostic in a hardware component established in a data processing system. The method includes starting a first slow mode initial program loading in the hardware component, wherein the hardware component contains a first diagnostic routine. A determination is made whether the first diagnostic routine fails during the slow mode initial program loading. Responsive to a determination that the first diagnostic routine fails, the first diagnostic routine is isolated.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which aspects of the present invention may be implemented.

FIG. 2 is a block diagram of a data processing system in which aspects of the present invention may be implemented.

FIG. 3 is a block diagram of a data processing system in which aspects of the present invention may be implemented.

FIG. 4 is a flowchart of a diagnostic process performed in hardware present in a data processing system, in accordance with an illustrative example of the present invention.

### DETAILED DESCRIPTION OF THE PREFERRED EMBODIMENT

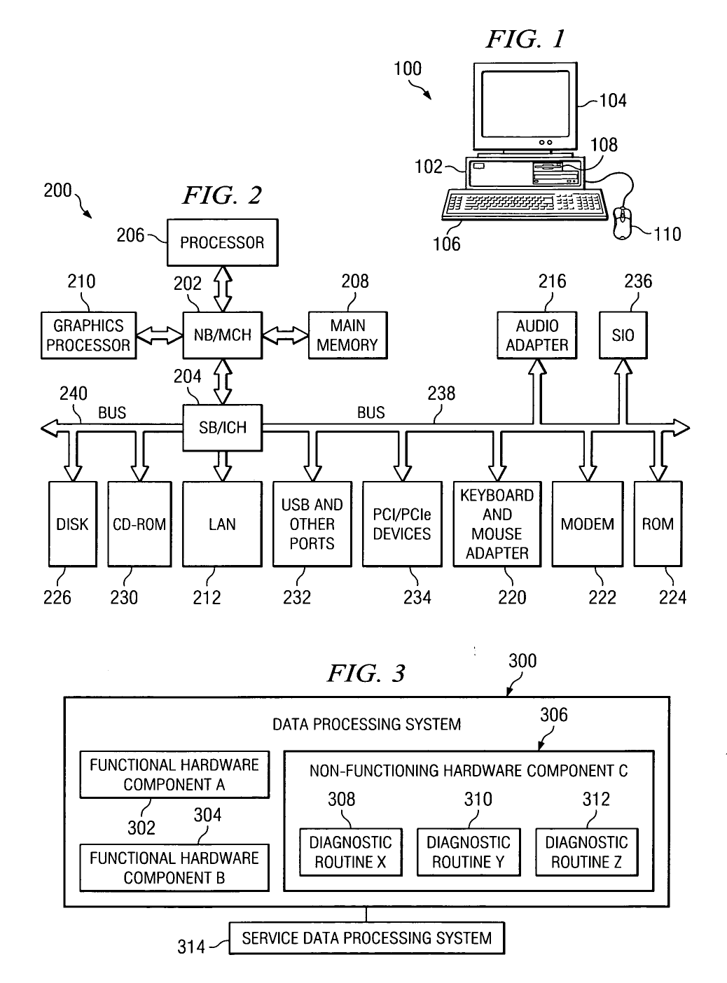

With reference now to the figures and in particular with reference to FIG. 1, a pictorial representation of a data processing system in which the aspects of the present invention may be implemented. Computer 100 is depicted which includes system unit 102, video display terminal 104, keyboard 106, storage devices 108, which may include floppy drives and other types of permanent and removable storage media, and mouse 110. Additional input devices may be included with personal computer 100, such as, for example, a joystick, touchpad, touch screen, trackball, microphone, and the like. Computer 100 can be implemented using any suitable computer, such as an IBM eServer computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface (GUI) that may be implemented by means of systems software residing in computer readable media in operation within computer 100.

With reference now to FIG. 2, a block diagram of a data processing system is shown in which aspects of the present invention may be implemented. Data processing system 200 is an example of a computer, such as computer 100 in FIG. 1, in which code or instructions implementing the processes of the present invention may be located. In the depicted example, data processing system 200 employs a hub architecture including a north bridge and memory controller hub (MCH) 202 and a south bridge and input/output (I/O) controller hub (ICH) 204. Processor 206, main memory 208, and graphics processor 210 are connected to north bridge and memory controller hub 202. Graphics processor 210 may be connected to the MCH through an accelerated graphics port (AGP), for example.

In the depicted example, local area network (LAN) adapter 212 connects to south bridge and I/O controller hub 204 and audio adapter 216, keyboard and mouse adapter 220, modem 222, read only memory (ROM) 224, hard disk drive (HDD) 226, CD-ROM drive 230, universal serial bus (USB) ports and other communications ports 232, and PCI/PCIe devices 234 connect to south bridge and I/O controller hub 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be connected to south bridge and I/O controller hub 204.

An operating system runs on processor 206 and coordinates and provides control of various components within data processing system 200 in FIG. 2. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provides calls to the operating system from Java programs or applications executing on data processing system 200 (Java is a trademark of Sun Microsystems, Inc. in the United States, other countries, or both).

Instructions for the operating system, the object-oriented programming system, and applications or programs are located on storage devices, such as hard disk drive 226, and may be loaded into main memory 208 for execution by processor 206. The processes of the present invention are performed by processor 206 using computer implemented instructions, which may be located in a memory such as, for example, main memory 208, read only memory 224, or in one or more peripheral devices.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the present invention may be applied to a multiprocessor data processing system.

In some illustrative examples, data processing system 200 may be a personal digital assistant (PDA), which is configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

The aspects of the present invention provide for a computer implemented method, apparatus, and computer usable program code for performing a diagnostic routine in a hardware component established in a data processing system. The aspects of the preset invention include starting a first slow mode initial program loading in the hardware component, wherein the hardware component contains a first diagnostic routine. “Slow mode initial program loading,” otherwise known as slow mode IPL, is a startup routine in a hardware component in which additional, non-critical diagnostic routines are executed in order to carefully asses whether the hardware component functions correctly. The term “diagnostic routine” means software or hardware that is adapted to diagnose a functionality of a hardware component. The term “slow mode initial program loading” is contrasted with the term “fast mode initial program loading.” The term “fast mode initial program loading,” otherwise known as fast mode IPL, means a startup routine in a hardware component in which additional, non-critical diagnostic routines are not executed during startup and/or only critical functionalities are enabled. In other words, the additional diagnostic routines are skipped. More generally, the term “initial program loading,” otherwise known as IPL is the startup routine for a hardware component.

A determination is made whether the first diagnostic routine fails during the slow mode initial program loading. Responsive to a determination that the first diagnostic routine fails, the first diagnostic routine is isolated. This process can be repeated if the hardware component contains additional diagnostic routines. In this manner, a hardware component that has non-defective functions can be run in a data processing system by isolating only those diagnostic routines that fail during a slow mode initial program loading.

FIG. 3 is a block diagram of a data processing system in which aspects of the present invention may be implemented. Data processing system 300 can be any computer or data processing system, such as computer 100 in FIG. 1 or computer 200 in FIG. 2. Hardware components 302, 304, and 306 can be any hardware components in a data processing system, such as audio adapter 216, disk 226, CD-ROM 230, or other hardware component shown in FIG. 2. Hardware components 302, 304, and 306 can also be any other hardware components, such as video cards, motherboards, or other hardware components. Thus, the term “hardware component” means a piece of hardware that is adapted to operate within or in conjunction with a data processing system. Examples of hardware components include, but are not limited to, motherboards, PCI cards, AGP cards, and memory.

Data processing system 300 in this illustrative example has three hardware components, including functional hardware component A 302, functional hardware component B 304, and non-functioning hardware component C 306. Each hardware component performs one or more functions relative to the operation of data processing system 300. For example, functional hardware component A 302 could be an audio card, though it could be any hardware component as described above. Functional hardware component A 302 and functional hardware component B 304 function normally, and thus are not discussed further in this application. However, non-functional hardware component C 306 does not function normally. The term “non-functional” can mean that non-functional hardware component C 306 does not function at all, operates erroneously or in an unintended manner, or that one or more functions performed by non-functional hardware component C 306 do not operate as desired, but that other functions within non-functional hardware component C 306 do function normally.

Removing or replacing non-functional hardware component C 306 from data processing system 300 can be difficult or undesirable. For this reason, performing a diagnostic routine to detect and isolate or repair the source of non-functionality is desirable. To that end, non-functional hardware component C 306 has one or more critical diagnostic routines and non-critical diagnostic routines. Critical diagnostic routines are diagnostic routines that are performed during an initial program loading, every time a hardware component is started. Non-critical diagnostic routines are diagnostic routines that need not be performed during an initial program loading every time a hardware component is started.

In the illustrative example of FIG. 3, diagnostic routine x 308, diagnostic routine Y 310, and diagnostic routine Z 312 are non-critical diagnostic routines. Non-functional hardware component C 306 can have additional critical diagnostic routines and non-critical diagnostic routines. Each of diagnostic routines X 308, Y 310, and Z 312 diagnose some functionality of non-functional hardware component C 306 during the initial program loading that occurs during startup. The term “functionality” means a function of a hardware component, and can include a sub-component of a hardware component or a diagnostic routine of the hardware component.

For example, diagnostic routine X 308 could be a diagnostic routine that checks if a sub-processor component within non-functional hardware component C 306 functions as desired. In another example, diagnostic routine Y 310 could be a diagnostic routine that checks if a particular program loaded in a non-volatile memory of non-functional hardware component C 306 functions as desired.

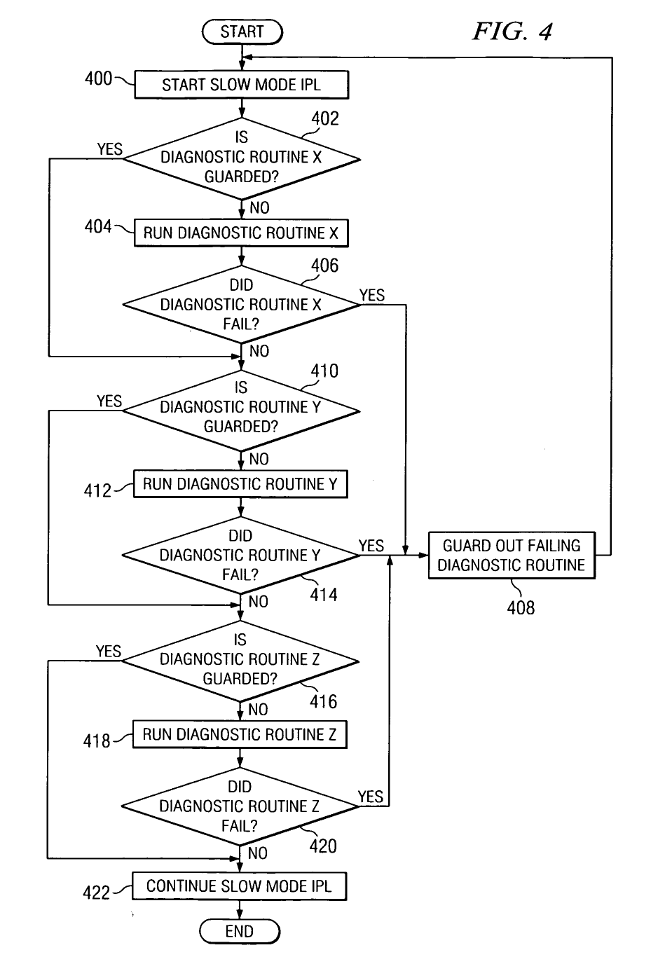

As described above, a problem that arises in hardware components that have multiple diagnostic routines is that errors found in one function can propagate errors in another function. Thus, an error found using diagnostic routine X 308 can cause an error that diagnostic routine Y 310 will find. For this reason, a user does not necessarily know whether both function X and function Y are non-functional, or whether only function X is non-functional. This problem can be resolved using the methods and devices described with respect to FIG. 4.

In the illustrative example, shown, service data processing system 314 initiates each initial program loading. However, in other embodiments, data processing system 300 can, itself, initiate one or more initial program loading. Service data processing system 314 can be any appropriate data processing system, and can be represented by data processing system 200 shown in FIG. 2. In an illustrative example, service data processing system 314 is a server.

FIG. 4 is a flowchart of a diagnostic process performed in hardware present in a data processing system, in accordance with an illustrative example of the present invention. The process shown in FIG. 4 can be implemented in a data processing system, such as data processing system 100 shown in FIG. 1, data processing system 200 shown in FIG. 2, or data processing system 300 shown in FIG. 3. The illustrative example shown in FIG. 4 is presented in the context of data processing system 300 of FIG. 3; however, the process shown in FIG. 4 can be expanded, reduced, or modified appropriately relative to the particular hardware component being tested. In an illustrative example, the processes shown herein are implemented using a separate data processing system, such as service data processing system 314 in FIG. 3, which can also be represented by the data processing system shown in FIG. 2.

Initially, a service data processing system starts a slow mode initial program loading (IPL) in the non-functional hardware component during startup of the non-functional hardware component (step 400). In this illustrative example, hardware component has non-critical diagnostic routines X, Y, and Z. A slow mode initial program loading is a startup routine in a hardware component in which additional, non-critical diagnostic routines are executed in order to carefully asses whether individual functionalities within the hardware component functions-correctly. An individual functionality can be the functionality of a sub-processor component within the hardware component, a functionality of a particular program loaded in a non-volatile memory of the hardware component, or any other functionality associated with the hardware component.

After starting the slow mode initial program loading, the service data processing system determines whether diagnostic routine X is isolated (step 402). The term “isolate” means that the diagnostic routine or the hardware function is isolated and prevented from functioning during operation of the hardware component. Thus, if a diagnostic routine is isolated, then that diagnostic routine will be skipped during subsequent executions of slow mode initial program loading. If a hardware function is isolated, then that function is prevented from starting up during an initial program loading or is prevented from functioning after an initial program loading. As used herein, the term “isolate” is synonymous with the term “guard.”

A diagnostic routine is isolated if the diagnostic routine or the hardware function being diagnosed is isolated and prevented from functioning during operation of the hardware component. Thus, if a diagnostic routine is isolated, then that diagnostic routine will be skipped during subsequent executions of slow mode initial program loading. Similarly, the hardware function associated which the diagnostic routine diagnoses is also isolated. If a hardware function is isolated, then that function is prevented from being started up during an initial program loading or is prevented from functioning after an initial program loading.

If diagnostic routine X is not isolated, then the hardware component runs diagnostic routine X within the hardware component (step 404). The service data processing system then determines whether diagnostic routine X failed (step 406). If diagnostic routine x did fail, then the service data processing system isolates diagnostic routine X (step 408).

However, if diagnostic routine X did not fail, or if diagnostic routine X is isolated, then the service data processing system determines whether diagnostic routine Y is isolated (step 410). If diagnostic routine Y is not isolated, then the hardware component runs diagnostic routine Y within the hardware component (step 412). The service data processing system then determines whether diagnostic routine Y failed (step 414). If diagnostic routine Y did fail, then the service data processing system isolates diagnostic routine Y (step 408).

However, if diagnostic routine Y did not fail, or if diagnostic routine Y is isolated, then the service data processing system determines whether diagnostic routine Z is isolated (step 416). If diagnostic routine Z is not isolated, then the hardware component runs diagnostic routine Z within the hardware component (step 418). The service data processing system then determines whether diagnostic routine Z failed (step 420). If diagnostic routine Z did fail, then the service data processing system isolates diagnostic routine Z (step 408).

If diagnostic routine Z did not fail, or if diagnostic routine Z is isolated, then the slow mode initial program loading for the hardware component continues (step 422). Eventually, the slow mode initial program loading is completed, at which point the process terminates.

The slow mode initial program loading diagnostic process shown in FIG. 4 can involve a large number of steps and diagnostic routines. To speed up initial diagnosis of the hardware component, the service data processing system can perform a fast mode initial program loading before performing the slow mode initial program loading. During fast mode initial program loading, the hardware component performs a startup routine in which additional, non-critical diagnostic routines are not executed during startup and/or only critical functionalities are enabled. In other words, the hardware component skips additional diagnostic routines and the hardware component performs only critical diagnostic routines and/or enables only critical functionalities. The service data processing system ensures that the hardware component performs these steps.

If a hardware component fails a fast mode initial program loading, then the hardware component should be replaced. The term “fails” means that diagnostic routine indicates that a failure has occurred in the hardware component. The failure can occur with respect to the diagnostic routine itself, or with respect to one or more functions in the hardware component that the diagnostic routine is adapted to test. If however, a hardware component passes an initial program loading, then the hardware component may benefit from isolating individual functions or diagnostic routines during a slow mode initial program loading.

The methods and devices described herein have several advantages over known methods of preventing conflicts in business systems caused by revised orders which are submitted before an initial order is completely processed. For example, individual functions or diagnostic routines of a non-functioning hardware component can be isolated without removing the entire hardware component. Thus, the functioning aspects of a non-functioning hardware component can continue operation until replacing the hardware component, repairing the hardware component, or otherwise resolving the non-functioning functionality or diagnostic can be performed. As a result, the methods and mechanisms of the present invention can save a business time and money. Additionally, the mechanisms of the present invention can be used to isolate error-prone functionalities or diagnostic routines in a hardware component and prevent errors in one functionality or diagnostic routine in that component from affecting other functionalities or diagnostic routines in that hardware component.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for performing a diagnostic in hardware components, the method comprising:
starting a slow mode initial program loading in a hardware component located in a data processing system, wherein the hardware component contains a diagnostic routine that is run during the slow mode initial program loading;
determining if the diagnostic routine fails during the slow mode initial program loading; and
responsive to a determination that diagnostic routine fails, isolating the diagnostic routine, wherein when isolated the diagnostic routine is prevented from functioning during operation of the hardware component.

2. The method of claim 1, wherein the slow mode initial program loading is a first slow mode initial program loading and wherein the method further comprises:
completing the first slow mode initial program loading; and
initiating a second initial program loading.

3. The method of claim 2, wherein the diagnostic routine is a first diagnostic routine, wherein the hardware component contains a second diagnostic routine, and wherein the method further comprises:
determining whether the first diagnostic routine is isolated;
responsive to a determination that the first diagnostic routine is isolated, skipping the first diagnostic routine;
determining if the second diagnostic routine fails during the second slow mode initial program loading; and
responsive to a determination that the second diagnostic routine fails, isolating the second diagnostic routine.

4. The method of claim 3 further comprising:
completing the second slow mode initial program loading.

5. The method of claim 4 wherein the second diagnostic routine is isolated and wherein the method further comprises:
determining if additional diagnostic routines should be run during additional executions of slow mode initial program loading;
responsive to determining that no additional diagnostic routines should be run, performing a fast initial program loading in which the first diagnostic routine and the second diagnostic routine are skipped.

6. A computer program product comprising:
a computer usable medium having computer usable program code for performing a diagnostic in a hardware component established in a data processing system, said computer program product including:
computer usable program code for starting a slow mode initial program loading in a hardware component located in a data processing system, wherein the hardware component contains a diagnostic routine that is run during the slow mode initial program loading;
computer usable program code for determining if the diagnostic routine fails during the slow mode initial program loading; and
computer usable program code for, responsive to a determination that diagnostic routine fails, isolating the diagnostic routine, wherein when isolated the diagnostic routine is prevented from functioning during operation of the hardware component.

7. The computer program product of claim 6, wherein the slow mode initial program loading is a first slow mode initial program loading and wherein the computer program product further comprises:
computer usable program code for completing the first slow mode initial program loading; and
computer usable program code for initiating a second initial program loading.

8. The computer program product of claim 7, wherein the diagnostic routine is a first diagnostic routine, wherein the hardware component contains a second diagnostic routine, and wherein the computer program product further comprises:
computer usable program code for determining whether the first diagnostic routine is isolated;
computer usable program code for, responsive to a determination that the first diagnostic routine is isolated, skipping the first diagnostic routine;
computer usable program code for determining if the second diagnostic routine fails during the second slow mode initial program loading; and
computer usable program code for, responsive to a determination that the second diagnostic routine fails, isolating the second diagnostic routine.

9. The computer program product of claim 8 further comprising:
computer usable program code for completing the second slow mode initial program loading.

10. The computer program product of claim 9 wherein the second diagnostic routine is isolated and wherein the computer program product further comprises:
computer usable program code for determining if additional diagnostic routines should be run during additional executions of slow mode initial program loading;
computer usable program code for, responsive to determining that no additional diagnostic routines should be run, performing a fast initial program loading in which the first diagnostic routine and the second diagnostic routine are skipped.

11. A data processing system comprising:
a processor;
a bus connected to the processor;
a hardware component connected to the bus, the hardware component containing a first diagnostic routine;
a computer usable medium connected to the bus, wherein the computer usable medium contains a set of instructions, wherein the processor is adapted to carry out the set of instructions to:
start a slow mode initial program loading in a hardware component located in a data processing system, wherein the hardware component contains a diagnostic routine that is run during the slow mode initial program loading;
determine if the diagnostic routine fails during the slow mode initial program loading; and
responsive to a determination that diagnostic routine fails, isolate the diagnostic routine, wherein when isolated the diagnostic routine is prevented from functioning during operation of the hardware component.

12. The data processing system of claim 11, wherein the slow mode initial program loading is a first slow mode initial program loading and wherein the processor is further adapted to carry out the set of instructions to:
complete the first slow mode initial program loading; and
initiate a second initial program loading.

13. The data processing system of claim 12, wherein the diagnostic routine is a first diagnostic routine, wherein the hardware component contains a second diagnostic routine, and wherein the processor is further adapted to carry out the set of instructions to:
determine whether the first diagnostic routine is isolated;
responsive to a determination that the first diagnostic routine is isolated, skip the first diagnostic routine;
determine if the second diagnostic routine fails during the second slow mode initial program loading; and
responsive to a determination that the second diagnostic routine fails, isolate the second diagnostic routine.

14. The data processing system of claim 13 wherein the processor is further adapted to carry out the set of instructions to:
complete the second slow mode initial program loading.

15. The data processing system of claim 14 wherein the second diagnostic routine is isolated and wherein the processor is further adapted to carry out the set of instructions to:
determine if additional diagnostic routines should be run during additional executions of slow mode initial program loading;
responsive to determining that no additional diagnostic routines should be run, perform a fast initial program loading in which the first diagnostic routine and the second diagnostic routine are skipped.

16. A data processing system for performing a diagnostic in a hardware component established in a data processing system, the data processing system comprising:
means for starting a slow mode initial program loading in a hardware component located in a data processing system, wherein the hardware component contains a diagnostic routine that is run during the slow mode initial program loading;
means for determining if the diagnostic routine fails during the slow mode initial program loading; and
means for, responsive to a determination that diagnostic routine fails, isolating the diagnostic routine, wherein when isolated the diagnostic routine is prevented from functioning during operation of the hardware component.

17. The data processing system of claim 16, wherein the slow mode initial program loading is a first slow mode initial program loading and wherein the data processing system further comprises:
means for completing the first slow mode initial program loading; and
means for initiating a second initial program loading.

18. The data processing system of claim 17, wherein the diagnostic routine is a first diagnostic routine, wherein the hardware component contains a second diagnostic routine, and wherein the data processing system further comprises:
means for determining whether the first diagnostic routine is isolated;
means for, responsive to a determination that the first diagnostic routine is isolated, skipping the first diagnostic routine;
means for determining if the second diagnostic routine fails during the second slow mode initial program loading; and
means for, responsive to a determination that the second diagnostic routine fails, isolating the second diagnostic routine.

19. The data processing system of claim 18 further comprising:
means for completing the second slow mode initial program loading.

20. The data processing system of claim 19 wherein the second diagnostic routine is isolated and wherein the data processing system further comprises:
means for determining if additional diagnostic routines should be run during additional executions of slow mode initial program loading;
means for responsive to determining that no additional diagnostic routines should be run, performing a fast initial program loading in which the first diagnostic routine and the second diagnostic routine are skipped.
